(19) United States
(12) Patent Application Publication
(10) Pub. No.: US 2007/0219896 A1
(43) Pub. Date: Sep. 20, 2007

(54) Methods and systems for facilitating investment in consumer interest in online media

(76) Inventors: Seth Goldstein, New York, NY (US); Peter Hershberg, New York, NY (US); Joshua Stylman, Brooklyn, NY (US)

Correspondence Address: JLB CONSULTING, INC.;c/o INTELLEVATE, P.O. BOX 52050, MINNEAPOLIS, MN, 55402, US

(21) Appl. No.: 11/125,512

(22) Filed: May 10, 2005

(51) Int. Cl. G06Q 40/00

(52) U.S. Cl. 705/37

(57) ABSTRACT

There is provided herein methods and systems for facilitating the trading, i.e. purchase and sale, of consumer interest arising from online media assets. A particular online media asset trading platform 102 is described, including various traffic capture 202, data mining, analytic 204 and customer lead sales 206 functions. Further provided is an investment structure 400 that facilitates private investment in the consumer interest arising from the online media assets traded by the trading system. The investment structure brings the discipline of the financial market directly to the management of online media assets, providing relative efficiency and predictability to online advertisers and publishers, and creating new opportunities for investors.

### FIELD OF THE INVENTION

The present invention relates generally to online media and more particularly to methods and systems for investing in the buying and selling of value generated through consumer interest in online media.

### BACKGROUND OF THE INVENTION

According to some estimates consumers spent over $100 billion making online purchases in 2004, buying products and services over the Internet. It has been further estimated that advertisers spend almost $10 billion per year in placing online advertisements. Indeed, many online retail business models rely heavily on paid advertising and/or commissions for sales made through online advertisements. The reader will thus appreciate that online markets, such as those supported by the Internet, represent a substantial source of heavily advertised retail opportunities.

Online media assets comprise electronic indicia used on electronic networks, for example the Internet, as advertisements for attracting customers. Online media assets can take many forms, including keywords, banners, traditional advertisements, graphical inserts, e-mail, domain names and others as are known to the reader. Online media assets are purchased by media buyers on behalf of online retailers and, as described above, used in Internet advertising to attract customers for the purpose of initiating online sales. Owning the appropriate online media assets can be critical to attracting online customers and consummating sales. By their nature, however, online media assets are limited in availability. A single banner ad, for example, can only be purchased at any given time by a single user. Similarly, advertising opportunities and graphical space within web pages are by their nature limited in availability.

Commercial online search engines Yahoo™ and Google™ both operate online keyword auction services. The Yahoo® Search Marketing service and the Google™ online auction service are well known to online media buyers. Google™ alone is estimated to have generated over $1 billion in advertising revenue in 2004. Valuable keywords and advertising media assets may sell for upwards of $150 per customer click-through.

The sale and purchase of online media assets, while necessary to a successful e-commerce market, poses many challenges to both buyers and sellers. Volatile demand for online media assets makes the management of inventory difficult for publishers, often generating uneven or unpredictable cash flow and resulting financial difficulties. Similarly, advertisers find the online media asset market to be complicated and inefficient.

One reason that online media assets are difficult to value is because the online media asset marketplace is fractured and inefficient. There is no central price discovery mechanism for comparing prices of ad impressions, paid search clicks, and direct response leads across multiple networks and marketplaces. A number of direct response agencies are beginning to acquire online media assets on a principal basis in an attempt to take advantage of the spread between the purchase costs and sales value of online media assets, as well as to provide some discipline. Most such agencies have been launched within the past 3-5 years. The reader is directed, for example, to Adteractive™, Azoogleads™, LeadClick™, NetBlue™ and Quin Street™ for examples of companies purchasing and reselling online media assets. The reader may consider right media™ as an example of a company that auctions advertising impressions and bluelith!um™ as an example of a company that helps advertisers and publishers optimize their advertising opportunities.

These agencies act as intermediaries between online publishers and online advertisers. In operation, they purchase online media assets from publishers, for example click—through advertisements and keywords, and resell them to advertisers. The agencies may purchase online media assets from publishers, for example, on an impression basis, while resale to advertisers may be priced, for example, on a CPA, or cost per action, basis. These agencies are currently generating substantial returns on their media costs by converting online traffic into customers more effectively than advertisers themselves. Publishers thus benefit through more efficient and cost-effective sales of online media assets, while advertisers benefit through the more cost-effective purchase of the same assets.

It will be appreciated by those skilled in the art that the operation of the above described online media resellers constitutes arbitrage. That is, these resellers purchase and sell inventory at substantially the same time, profiting from the margins between the buying price and the selling price.

Because of the structure of these online media asset resellers, it will be further appreciated by the reader that any efficiencies provided by the online media asset resellers are limited to those efficiencies that can be generated through the conventional supply and demand dynamics of the online media asset market. That is, the efficiencies are generally limited by conventional retail dynamics as determined by the profitability of privately and publicly traded online media asset resellers. In their current form these online media asset resellers fail to provide to investors the ability to invest directly in online media assets, limiting investment opportunities to those that may be available in the operating companies.

While online media asset resellers provide some efficiency and improvements to the online media asset market, the market still suffers from much significant inefficiency. Volatility of buyer/advertiser demand for online media assets makes the efficient sale of online advertising difficult for sellers/publishers, while an inefficient, fractured market makes appropriate valuation difficult for advertisers.

### SUMMARY OF THE INVENTION

The present inventors have determined that it would be desirable and beneficial for both the online media asset market and investors to provide the ability for investors to participate directly in the function of the online media market. This is accomplished by providing methods and systems for securitizing online media assets, the media assets in the form generally of consumer interest, for financial investment by investors. It is believed that the efficiencies generated by investor-driven dynamics would improve the online media asset market, resulting in a more efficient market for both publishers and advertisers, and creates new opportunities for investors.

In accordance with one embodiment of the present invention, there are shown methods and systems for facilitating investment in consumer interest in online media assets, a system comprising: a trading system for buying and selling online media assets, the online media assets used to generate consumer interest; means for securitizing the consumer interest; and means for enabling investments in the securitized consumer interest.

In accordance with another embodiment of the present invention, there are shown methods and systems for facilitating investment in consumer interest in online media assets, a method comprising: establishing a trading system for buying and selling online media assets; generating consumer interest from consumer selections of the online media assets; the trading system further operative to buy and sell the consumer interest; establishing a management company to operate the trading system; establishing a limited partnership to invest funds for management by the management company in the operation of the trading system; and receiving investor funds into the limited partnership; whereby investors in the limited partnership own a financial interest in the consumer interest.

In accordance with another embodiment of the present invention, there are shown methods and systems for enabling investors to invest in consumer interest in online media assets, a method comprising: means for arbitraging real-time online consumer leads to generate an arbitrage value; means for securitizing the arbitrage value of the real-time online consumer leads; and means for using investor funds to purchase an interest in the arbitrage value of the real-time online consumer leads.

Through the securitization of Internet customer preferences and ‘intent to purchase’ using a Wall Street-like trading discipline, the present invention brings significant efficiencies to the online media asset and market, while providing investors the ability to recognize investments and return in this same market.

### DESCRIPTION OF THE DRAWING FIGURES

These and other objects, features and advantages of the present invention will be apparent from a consideration of the following Detailed Description of the Invention, when considered in cooperation with the drawing Figures, in which:

FIG. 1 is a block diagram of an online media asset trading system in accordance with the present invention;

FIG. 2 is a block diagram of the online media asset trading system of FIG. 1, showing functional aspects of the system;

FIG. 3 is a block diagram showing more detailed functional aspects of the online media asset trading system in accordance with the present invention;

FIG. 4 is a block diagram illustrating a corporate and investment structure in accordance with the present invention;

FIG. 5 is a flow chart showing at a high level a process for managing online media assets in accordance with the present invention;

FIG. 6 is a flow chart showing the details of the media asset processing step of FIG. 5; and

FIG. 7 is a flow chart showing a more detailed process for trading online media assets in accordance with the present invention.

### DETAILED DESCRIPTION OF THE INVENTION

The present invention shows an online media trading system wherein the online media assets are securitized for investment by investors. In the described embodiments of the invention, the online media assets are in the form of consumer interest, also described as consumer leads, for example as indicated by a consumer selection or ‘click-through’ of an advertising impression. The invention enables direct investment in the relative performance of online advertising, directly relating the return in an investment securitized by media assets to the to the generation of consumer interest in those assets, thereby bringing the disciplines and benefits of a Wall Street—type investment structure to the field of online media buying and selling.

As used herein, the term “securitization” and variants thereof is meant in the conventional sense as a process of creating a financial instrument by combining financial assets for marketing to investors. The reader will appreciate that the underlying financial assets described and securitized herein comprises the value associated with consumer interest in the online media asset inventory managed by the online media trading system.

Further as used herein, the term “media assets” and variants thereof means keywords, banners, traditional advertisements, graphical inserts, e-mail, domain names and others as are known to the reader.

Further as used herein, the terms “consumer interest,” “consumer leads,” and variants thereof mean demonstrated consumer response to an online media asset, for example the selection or “click—through” of an online media asset. As described in further detail below the present invention recognizes that there is real, securitizable value associated with consumer interest in online media assets.

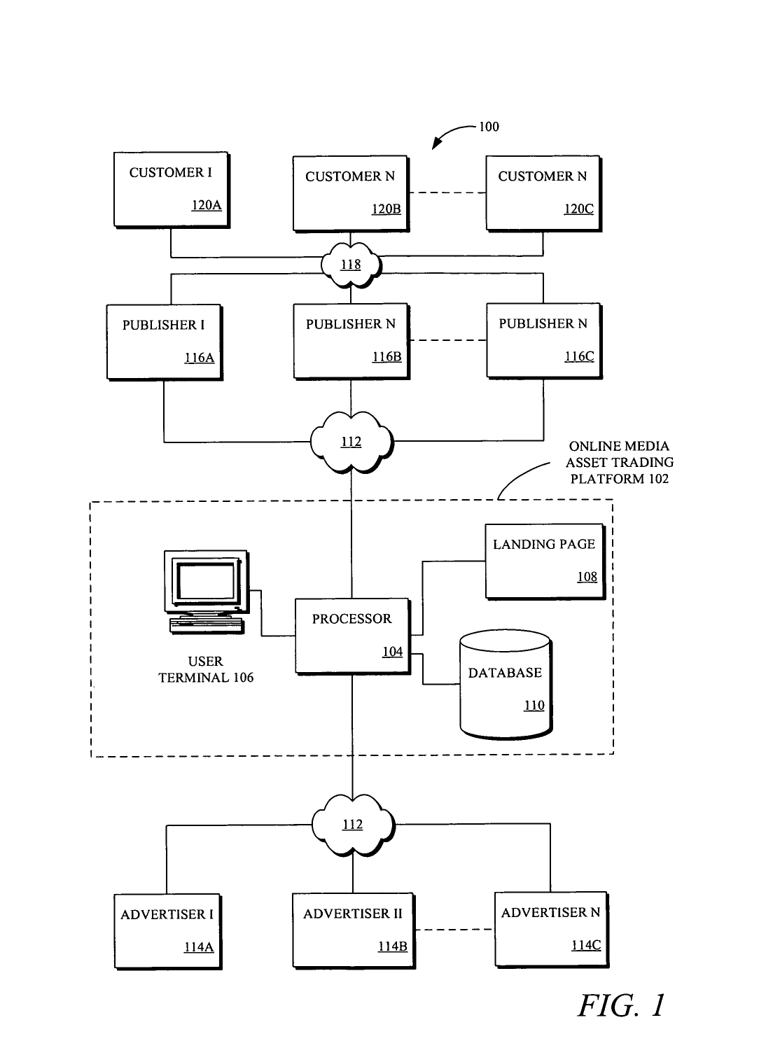

With reference now to FIG. 1, there is shown a system 100 including an online media asset trading platform 102. Online media asset trading platform 102 is seen to include a processor 104 connected to a user terminal 106, a landing page 108 and a database 110. The processor 104 is connected through conventional network connections, for example the Internet as shown at 112, to communicate with a variety of external parties.

Continuing with reference to FIG. 1, processor 104 is seen to be connected to communicate with a plurality of advertisers 114, three of which are indicated at 114A, 114B and 114C. Similarly, processor 104 is seen to be connected to communicate with a plurality of publishers 116, three of which are indicated at 116A, 116B and 116C. The publishers are connected so as to serve advertisements through a network 118, such as the Internet, to a plurality of customers 120, three of which are indicated at 120A, 120B and 120C. The interactions of advertisers 114, publishers 116 and customers 120 are described in further detail herein below.

It will be appreciated that media trading platform 102 can comprise conventional system components situated and programmed to perform the described elements of the present invention. Processor 104 can comprise, for example, a conventional network server with a conventional microprocessor and operating system. User terminal 106 can comprise a conventional keyboard and display device. Database 110 can comprise a conventional arrangement of memory, for example an appropriate combination of semiconductor, magnetic and optical storage. As is further described below, landing page 108 is seen to comprise a specialized, customer—accessible web page, for example assembled and stored in database 110 and managed appropriately by processor 104. It will be understood by the reader that while online media asset trading platform 102 has been shown in simplified form, in actual construction it can comprise one of many known configurations, for example a centralized system and/or a decentralized system comprising the described components in multiple and/or decentralized configurations.

Publishers 116 comprise online content publishers, many of which are known to the reader. Advertisers 114 comprise online advertisers, for example retail advertisers, who desire to purchase online media for the purpose of placing advertisements through publishers 116 for display to customers 120. It will be understood by the reader that in many instances a single entity can comprise both a publisher and an advertiser. Amazon.com™, for example, is a well-known online retailer who both publishes content pages including advertising as well as purchases advertising from others.

Like elements throughout the Figures are indicated by like reference numbers.

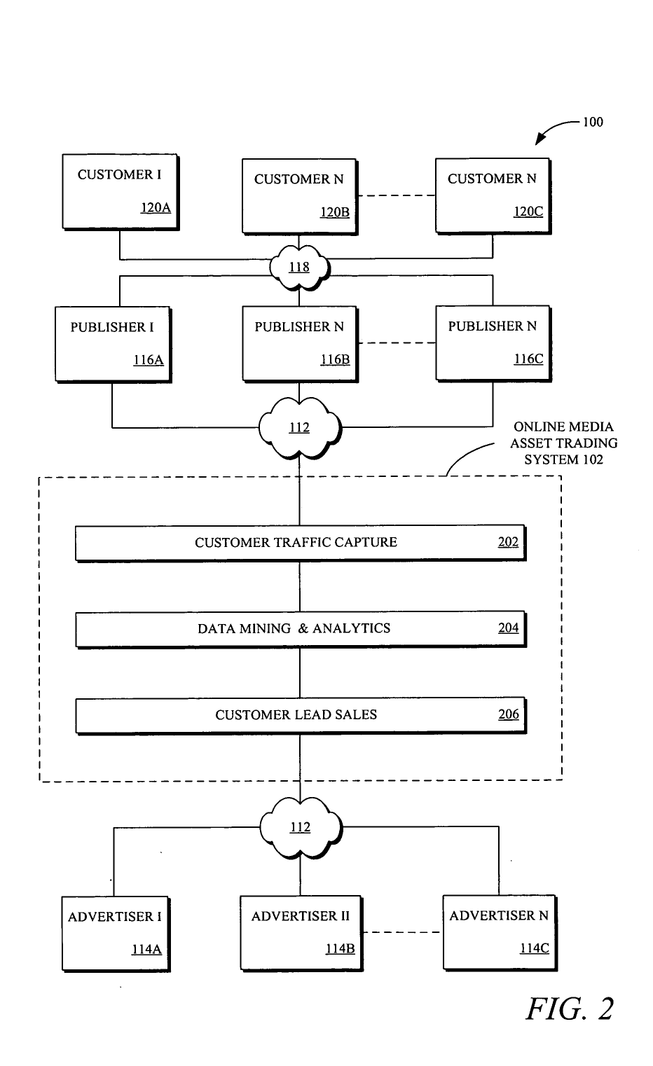

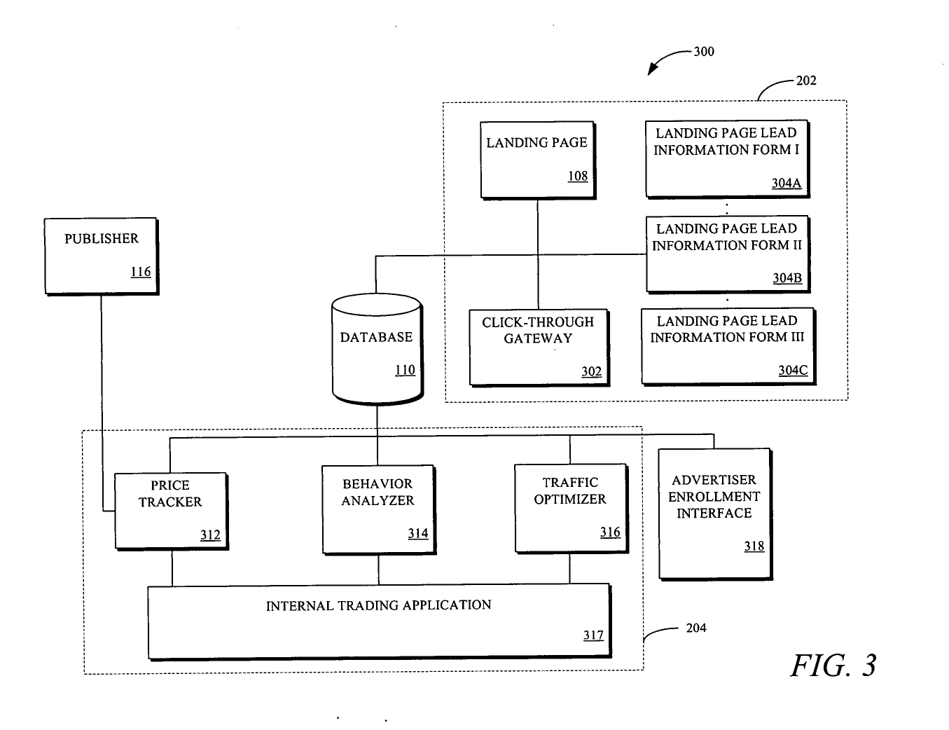

With reference now to FIGS. 2 and 3 functional aspects of platform 102 are shown. Firstly, with respect to FIG. 2, platform 102 is seen to include customer traffic capture means 202, data mining and analytic evaluation means 204 and customer lead sales means 206.

With reference to FIG. 3, customer traffic capture function 202 is seen to include a click—through gateway 302, landing page 108, and a plurality of landing page lead information forms 304, three of which are indicated at 304A, 304B and 304C, the click—through gateway, landing page and information forms all connected to database 110. (Database 110 is of course connected to processor 104 as shown in FIG. 1.)

Continuing with reference to FIG. 3, data mining & analytic means 204 is seen to include a price tracker 312, a behavioral analyzer 314 and a traffic optimizer 316, each connected to database 110 and an internal trading application 317. Price tracker 312 is seen to be connected to an ad publisher 116, while the components of data mining analytic means 204 are connected to an advertiser enrollment interface 318. Customer lead sales means 206 comprises advertiser enrollment interface 318 as well as components of internal trading application 317 that enable the sale of customer leads to advertisers as described herein.

Considering now the operation of the functional elements of FIGS. 2 and 3, it will be understood that online media asset trading platform 102 operates to purchase online media assets from publishers 116, and collect customer 120 click—through traffic, resulting from customer selection of the online media assets, for sale to advertisers 114. Click—through gateway 302 functions to serve cookies and track referrals and other foot-printing information relevant to customers 120 who select online media assets owned by trading platform 102. Almost instantaneously, the click—through traffic received onto gateway 302 is redirected to landing page 108. The operation of click—through gateway 302 is substantially imperceptible to a customer 120.

Landing page 108 functions as a dynamic web site to present a customer 120 with relevant information. The landing page further functions as a point to collect possible lead information. Lead information forms 304, in the described embodiment contained within the landing page 108, provide forms for collecting customer information. Exemplary forms and information collected include: contact details, customer demographics and other lead—specific information. Numerous other customer information and appropriate forms for collecting same will now be apparent to the reader.

Considering now the operation of data mining and analytic means 204, price tracker 312 functions to gather current inventory price information, for example through public and private data sharing facilities provided by the Yahoo® and Google® keyword auction sites described above. The current inventory price information is integrated with observed conversion rates, as observed by behavior analyzer 314, to optimize online media trades. Behavior analyzer 314 functions to analyze click—stream data as observed through the consumer traffic passing through click-through gateway 302 to landing page 108, whereby to process post-landing page behavior to determine the conversion rate of consumer traffic to lead sales. The analysis is used to optimize offers displayed to landing page customers, thus optimizing the overall success and profitability of the system.

Additionally, the data developed by behavior analyzer 314 is used to match possible leads with lead purchase requests. Traffic optimizer 316 functions to reconfigure landing pages 108 to optimize conversion and lead acquisition. Internal trading application 312 presents human traders/operators of asset trading system 100 with the data developed by the tracking, analyzing and optimizing functions described above, for use in selling media to advertisers 114.

Continuing with reference to FIG. 3, advertiser enrollment interface 318 comprises a web site where advertisers 114 interested in purchasing consumer leads developed from online media assets can register their demand for such consumer interest. The interface further provides for the ability to collect useful information from the advertisers, such as desired consumer demographics and preferences, etc., of potential customer information supplied to the advertisers. This information is used by the operators of trading application 317 to buy and sell online media assets in the processes described herein.

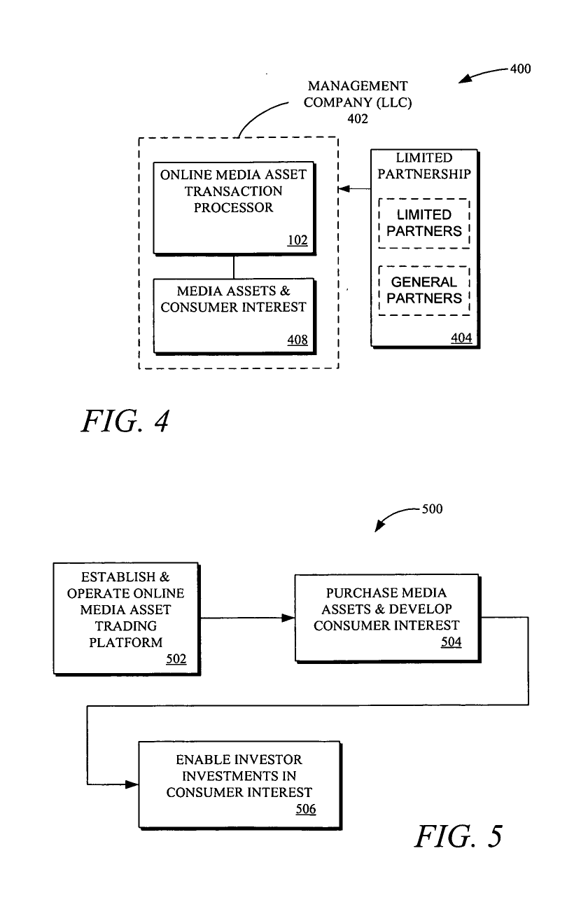

With reference now to FIG. 4, in accordance with one key aspect of the invention there is shown a new and unique business structure 400 including an operating management company 402 established in the form of a limited liability corporation (LLC). Management company 402 owns and operates the trading platform 102 and its assets, including the consumer interest assets described above and indicated at 408 in FIG. 4. Management company 402 further receives and directs the use of investment funds from a limited partnership 404. Limited partnership 404 includes, in a conventional sense, general partners who direct the operation of the limited partnership and limited partners liable only to the extent of their investments in the limited partnership.

Limited partnership 404 receives and invests the limited partner's investment funds. Limited partnership 404 further functions to allocate, reinvest and distribute investment profits and losses recognized by the limited partnership, among the limited partners and general partners of the limited partnership, through the investment in the assets of management company 402 and other investments as may be made by the limited partnership. As noted above, management company 402 owns the assets and resources of the trading platform and operates the trading platform, in exchange for compensation paid by the limited partnership, typically as a fee calculated as a percentage of the limited partnership assets invested under the direction of the management company.

From a consideration of the above it will be apparent to the reader that the present invention enables the direct investment by investors in the consumer interest owned and managed by asset trading system 102. It will be understood that, while limited partnership 404 is described as owning an interest in only a single management company 402, in practice it may own ownership interests in a portfolio comprising multiple operating companies or finds.

With reference now to FIG. 5, there is shown a process 500 for enabling investors to invest in online media assets in accordance with one embodiment of the present invention. Initially, there is established and operated online media asset trading platform 102 in accordance with the above described embodiments (step 502). Subsequent to the establishment of the trading platform, online media assets are purchased by the trader/operators of management system 102 and used to develop consumer interest (step 504).

With the establishment and operation of trading platform 102, there is performed a process enabling investments in the consumer interest by investors (step 506).

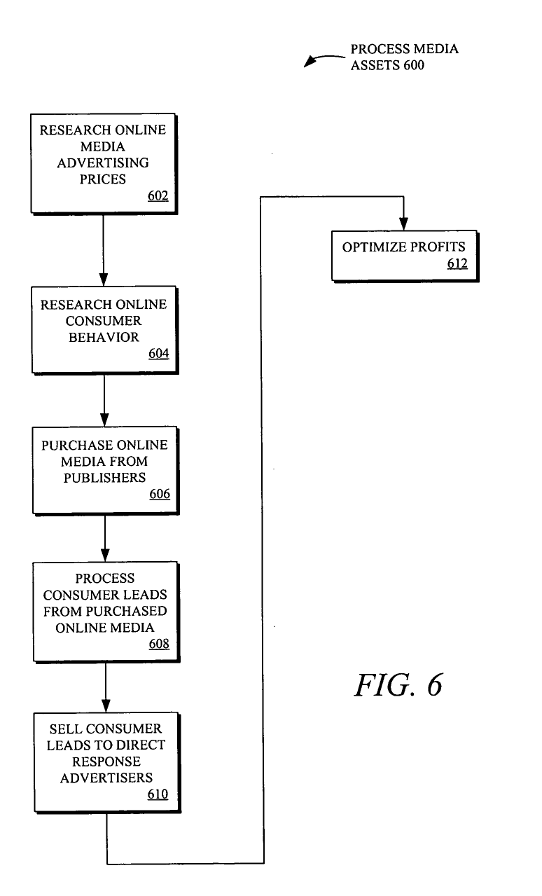

With reference now to FIG. 6, there is shown a process 600 whereby purchased online media assets are managed by online media trading system 102 (FIG. 1) to develop consumer interest. It will be understood that by the reader that process 600 comprises details of the above—described steps 500, 502 (FIG. 5).

Initially, research is performed regarding existing online media advertising prices (step 602), for example using the price tracking mechanism 312 from FIG. 3. The research may be based, for example, on observed changes in media asset prices coupled with observed changes in their lead generation capability, such changes indicating direction to media asset traders working within media trading platform 102.

Online consumer behavior is researched (step 604), for example using behavior analyzer 314 of FIG. 3. The purpose of this behavior research is to identify the relationships between user responses to advertising generated from media assets, thereby determining the optimal processes to cost-effectively convert consumer interest to valuable consumer lead sales.

Online media assets are then purchased from publishers 116 (step 606), for example through the keyword auction sites described herein. Consumer leads are processed from the purchased online media (step 608) for example using the customer traffic capture function 202 described with respect to FIGS. 2 and 3 above.

Continuing with respect to FIG. 6, the collected and processed consumer leads are sold to direct response advertisers 114 (step 610), for example using the internal trading application 312 described with respect to FIG. 3 above. The purchase and sale of online media are analyzed in an iterative process (step 612) in order to optimize the profits associated there-with. This optimization can be performed by different methods, for example: i) adjusting buy and sell prices of media assets, ii) adjust buy and sell of media assets based on recognized risk associated with those assets, iii) fine-tuning consumer experiences through the adjustment of landing pages, and iv) numerous other methods as will now be apparent to the reader.

It will be understood by the reader that the above-described operation of online media asset trading system 102 is exemplary in nature. Many alternative embodiments will now be apparent to the reader. It will be understood the processing of such online media assets whereby to generate salable, securitizable consumer interest is pertinent to the ability of investors to invest in the online media as described herein above. The invention is not limited to any particular embodiment of processing online media.

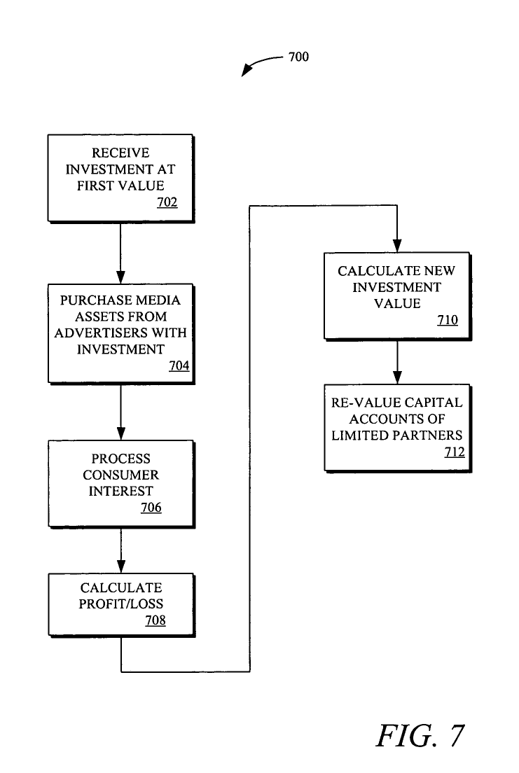

With reference now to FIG. 7, there is shown a process 700 for facilitating an investor investment in media assets as described with respect to FIG. 5 above. Initially, financial investments are received from investors through limited partnership 404 (FIG. 4) (step 702). Investor financial investments are invested by limited partnership 400 into management company 402, whereby they are managed by the management company in the operation of the operating company, including the purchase and sale of media assets (step 704). Management company 402 manages and processes the media assets in accordance with the above—described processes to generate and sell consumer interest (step 706) to advertisers 114, recognizing profits and losses.

Conventional profit and loss determinations are made with respect to management company 402 based upon the purchase and sale of online media assets and consumer interest in accordance with the above-described processes (steps 708). Based on such profits and losses, the evaluation of the limited partnership investment in the management company is periodically recalculated (step 710). Through this process, and further in consideration of the fees paid to the management company, the capital account value of the partners in limited partnership 404 is periodically re-assessed (step 712).

There have thus been provided methods and systems for facilitating private investment in online media assets, particularly in the form of consumer interest as represented by consumer leads. The present invention enables investors, for the first time, to directly own interests in the value of the consumer interest. This brings investment—type structure and uniformity to the business of online media asset trading. The invention thus provides for relative efficiency and predictability in the business of online media asset trading, providing business predictability and security to publishers and advertisers, and creates new opportunities for investors. The invention has application in the field of online advertising, and particularly in the field of Internet e-commerce.

What is claimed is:

1. A system for facilitating investment in consumer interest in online media assets, comprising:
a trading system for buying and selling online media assets, the online media assets used to generate consumer interest;
means for securitizing the consumer interest; and
means for enabling investments in the securitized consumer interest.

2. The system of claim 1 wherein the consumer interest comprises a real-time consumer lead generated through a consumer selection of an online media asset.

3. The system of claim 2 wherein the online media assets are selected from the group comprising keywords, banners, traditional advertisements, graphical inserts, e-mail and domain names.

4. The system of claim 1 wherein the means for securitizing the consumer interest includes a management company for owning the consumer interest.

5. The system of claim 4 wherein the means for means for enabling investments in the securitized consumer interest includes a limited partnership for providing investment funds managed by the management company in the operation of the trading system.

6. A process for facilitating investment in consumer interest in online media assets, comprising:
establishing an electronic trading system for buying and selling online media assets on a network;
using the online media assets to generate consumer interest;
securitizing the consumer interest for financial investment; and
enabling investments in the securitized consumer interest.

7. A system for facilitating investment in consumer interest in online media assets, comprising:
a network;
a processor connected to the network;
a memory connected to the processor storing instructions to control the operation of the processor to perform the steps of:
establishing an electronic trading system for buying and selling online media assets on a network;
using the online media assets to generate consumer interest;
securitizing the consumer interest for financial investment; and
enabling investments in the securitized consumer interest.

8. A method for facilitating investment in consumer interest in online media assets, comprising:
establishing a trading system for buying and selling online media assets;
generating consumer interest from consumer selections of the online media assets;
the trading system further operative to buy and sell the consumer interest;
establishing a management company to operate the trading system;
establishing a limited partnership to invest funds for management by the management company in the operation of the trading system; and
receiving investor funds into the limited partnership;
whereby investors in the limited partnership own a financial interest in the consumer interest.

9. The method of claim 8 wherein the online media assets are selected from the group comprising keywords, banners, traditional advertisements, graphical inserts, e-mail and domain names.

10. The method of claim 8 wherein the consumer interest comprises the selection by a consumer of a link in a graphical user interface.

11. The method of claim 8 and further comprising the step of periodically determining a profit on the investor funds in the limited partnership based on the financial performance of the management company resulting from the operation of the trading system.

12. The method of claim 11 and further comprising the step of operating the trading system, by the management company, to recognize a profit on the buying and selling of the consumer interest.

13. A system for facilitating investment in consumer interest in online media assets, comprising:
means for establishing a trading system for buying and selling online media assets;
means for generating consumer interest from consumer selections of the online media assets;
the means for establishing a trading system further including means for buying and selling the consumer interest;
means for establishing a management company to operate the trading system;
means for establishing a limited partnership to invest funds for management by the management company in the operation of the trading system; and
means for receiving investor funds into the limited partnership;
whereby investors in the limited partnership own a financial interest in the consumer interest.

14. A system for enabling investors to invest in consumer interest in online media assets, comprising:
means for arbitraging real-time online consumer leads to generate an arbitrage value;
means for securitizing the arbitrage value of the real-time online consumer leads; and
means for using investor funds to purchase an interest in the arbitrage value of the real-time online consumer leads.

15. The system of claim 14 wherein the arbitraging means includes:
a trading system for trading online media assets; and
the trading system including means for selling consumer interest in the online media assets.

16. The system of claim 15 wherein the securitizing means includes a management company for owning the trading system.

17. The system of claim 16 wherein the using means includes a corporate structure for investing investor funds in the management company.

18. The system of claim 14 wherein the online media assets are selected from the group comprising keywords, banners, traditional advertisements, graphical inserts, e-mail and domain names.

19. The system of claim 18 wherein the online consumer leads result from consumer selection of the online media assets.

20. A method for enabling investors to invest in consumer interest in online media assets, comprising:
establishing an electronic management system to arbitrage real-time online consumer leads to generate an arbitrage value;
securitizing the arbitrage value of the real-time online consumer leads; and
using investor funds to purchase an interest in the arbitrage value of the real-time online consumer leads.
